(19) United States
(12) Patent Application Publication
(10) Pub. No.: US 2002/0134791 A1
(43) Pub. Date: Sep. 26, 2002

(54) Universal blast aerator nozzle

(75) Inventors: Rodney D. Treat, Benton, AR (US); Stanislav Kligman, Little Rock, AR (US)

Correspondence Address: Stephen D. Carver, 2024 Arkansas Valley Drive, # 800, Little Rock, AR, 72212-4147, US

(73) Assignee: Global Mfg. Inc.

(21) Appl. No.: 10/101,285

(22) Filed: Mar. 19, 2002

Related U.S. Application Data
(60) Provisional application No. 60/277,004, filed on Mar. 20, 2001.

(51) Int. Cl. B65G 69/06; B65D 88/74

(52) U.S. Cl. 222/3; 222/192; 222/195; 222/1

(57) ABSTRACT

A rigid, one piece nozzle for blast aerators is configured to be mounted in a variety of operating orientations within and upon applications of widely varying shapes and geometry. The generally triangular nozzle comprises a flat base and a spaced-apart, arcuate top, secured to the base by a pair of opposed side walls. An inlet orifice in the flat body portion is internally configured like a truncated cone, and communicates with the nozzle discharge orifice thorough the hollow interior of the nozzle. The inlet is conical to permit the feed pipe to be mated and welded to it once the parts are properly oriented by the installer. An airtight seal results during welding, as the void between the pipe periphery and the circumference the inlet seat the weldment. Because the feed pipe may be fitted to the nozzle at so many angles and orientations, it is suitable for a wide variety of job applications.

### CROSS REFERENCE TO RELATED APPLICATION

This utility application is based upon and claims the filing date and priority of previously filed and currently pending U.S. Provisional Patent Application Serial No. 60/277,004, filed Mar. 20, 2001, and entitled Universal Blast Aerator Injection Nozzle.

### BACKGROUND OF THE INVENTION

I. Field of the Invention

This invention relates generally to air-accumulator and discharge devices of the type generally known as air blasters, air cannons, or blast aerators of the type classified in United States Patent Class 222, Subclasses 2 and 3, and Class 251, Subclass 30.02. More particularly, the present invention relates to blast aerator output nozzles classified in U.S. Class 222, Subclasses 192 and 195.

II. Description of the Prior Art

As is well know to those with skill in the art, the passage of bulk materials through conventional handling equipment is often degraded or interrupted. Typical bulk materials comprise concrete mixtures, grains, wood chips or other granular materials disposed within large hoppers or storage bins. In conventional, conically shaped hoppers, for example, bridges or arches of bulk materials often form, preventing or minimizing the orderly flow or delivery of granular materials. Often, “rat holes” or funnels build up, and material passage is severely degraded or halted altogether. Particles of bulk material may form cohesive bonds either by adhesion due to chemical or hydrostatic attraction, or particles may interlock because of horizontal and vertical compression. Such materials usually tend to cake or congeal during bulk processing. When moisture accumulates, unwanted caking tends to block flow. It is also recognized that friction between bulk material and the walls of a typical bunker or hopper in which the material is confined tends to interfere with proper flow.

Blast aerators or air cannons have long been employed to dislodge blocked or jammed bulk material. Storage bins or hoppers, for example, are often fitted with one or more high pressure air cannons that periodically blast air into the interior to dislodge caked particles, break funnels and bridges, and destroy rat holes. Bulk flow problems can temporarily be stopped by physically vibrating the hopper or container to shake loose the jammed materials. But not all materials may be dislodged in this manner. For example, large concrete bunkers may be impossible to vibrate. Materials like soft wood chips ordinarily absorb vibratory energy and must be dislodged by other methods.

Air blasters are preferred over vibrators because of efficiency. The forces outputted by blast aerators are applied directly to the material to be dislodged, rather than to the walls of the structure. Modern air blasters are also preferred over air slides, air wands, and various air screen devices which operate at low pressures. Live bottoms in hoppers or bins are limited in their effectiveness, since they may tend to create bridging or arching of material. Modern air cannons or blast aerators are intended for use as a flow stimulator against materials that are primarily moved by gravity. They are not intended to be the prime movers of such materials, and for safety purposes they should not be used to initiate the flow or movement of bulk materials unless a gravity feed is employed.

Typical blast aerators comprise a large, rigid holding tank that relatively slowly accumulate air supplied through the H.P. air lines available at typical industrial facilities. A special valve assembly associated with the tank includes a high volume discharge opening directed towards or within the target application. The valve structure periodically activates the air cannon, and the large volume of air that was slowly accumulated in the holding tank is rapidly, forcibly discharged within a few milliseconds. The volume of compressed air released by a typical quick opening valve in a modern blast aerator strikes the bulk material at a rate exceeding 1000 feet-per-second. Materials exposed to this high volume inrush are forcibly dislodged by impact.

U.S. Pat. No. 4,469,247, issued Sep. 4, 1984, and owned by Global Manufacturing Inc., discloses a blast aerator for dislodging bulk materials. The blast aerator tank has a blast discharge opening coaxially aligned with its longitudinal axis. The blast discharge assembly comprises a rigid, tubular feed pipe comprising an internal shoulder that forms a valve seat. A resilient piston coaxially, slidably disposed within the pipe abuts the valve seat to seal the tank during the fill cycle. In the fill position the seal is maintained by a chamfered end of the piston that matingly, sealingly contacts a similarly chamfered seat portion of the valve seat assembly. A cavity at the piston rear is pressurized to close the valve by deflecting the piston. During periodic cycles, discharge occurs in response to cavity venting, whereupon the piston is rapidly displaced away from the valve seat, exposing the feed pipe opening to the pressurized tank interior.

Blast aerators characterized by the foregoing generalized structure may be seen in U.S. Pat. Nos. 3,651,988; 3,915,339; 4,197,966; 4,346,822; and 5,143,256. Other relevant blast aerator technology may be seen in Great Britain Pat. Nos. 1,426,035 and 1,454,261. Also relevant are West German Patent 2,402,001 and Australian Pat. No. 175,551.

Global Manufacturing patent No. 4,496,076 teaches a method of employing a plurality of air cannons in a controlled array.

In some prior art aerator designs, the piston and valve assembly are disposed at a right angle relative to the discharge flow path. In addition, many blast aerators use a valve assembly that is mounted externally of the accumulator tank. The latter design features are seen in U.S. Pat. Nos. 3,942,684; 4,767,024; 4,826,051; 4,817,821; and 5,853,160.

U.S. Pat. No. 5,441,171 discloses a protrusion on the rear of a slidably captivated piston to help slow the piston after firing. This design does not bleed air off in a controlled fashion and in fact the protrusion does not shut off the flow of air out of the valve body.

U.S. Pat. No. 5,517,898 discloses a pneumatic cylinder in which coaxially disposed “pistons” include dampening sleeves. In other words, ports are interconnected with internal passageways including stem portions of the cylinder to dampen piston movement by compressed air.

The large volume of air outputted by the aerator is applied via suitable nozzle disposed within the target hopper or bin. The nozzle is connected to the aerator through suitable piping. The nozzle is fixedly mounted at a selected angle or orientation upon the internal walls of the hopper or bin. Air blasts transmitted to the nozzle through suitable piping are aimed at the material to be forcibly dislodged. When the nozzle jets are properly aimed and the nozzle is properly mounted, the blast of the shock wave rapidly destroys formations of bulk material that might otherwise hinder fluid flow. The rigid nozzle is usually mounted by the aerator user upon a flat or recessed, internal wall surface of the hopper or bin. The nozzle must be carefully mounted such that the output is properly directed at the intended application, and so that the nozzle may be conveniently coupled to the aerator feed pipe at a comfortable angle. Once the connection between the nozzle and the feed pipe is initially established by the installer, the nozzle is welded in place.

However, conventional nozzles present many mounting difficulties. At a given angular configuration, the input orifice to the nozzle must adequately admit the feed pipe, without gaps or holes that are too large to be covered by welding, and preferably without bushings or added seals. Often the feed pipe approaches the nozzle at an inconvenient angle. Sometimes a sizable portion of the nozzle is mounted within a recessed area of the wall. Moreover, the internal walls of the application may be severely inclined at extreme acute or obtuse angles that make mounting difficult. Compounding the latter problems is the fact that the nozzle output must be aimed at the bulk material to be dislodged, often forcing it to assume an oblique or inconvenient angle relative to feed pipe. In other words, the proper nozzle orientation necessary for optimal functioning is often quite difficult to implement by installer. As a result, for a given blast aerator installation, the installer may need several different nozzles on hand varying both in size and dimension, in order to fit the circumstances.

In the prior art the nozzle orifice is elliptical. As is well known to those with skill in the art of geometry, the common connection (interference) between a cylindrical part and an orifice in a flat part that are joined at an angle different from 90° is achieved by configuring an opening in the flat part (i.e., the hole in the body of the nozzle) to correspond with the profile of the cut section of the cylindrical part. Stated another way, when a plane cuts a cylinder at an angle of ninety degrees relative to the longitudinal axis of the cylinder, the resultant “trace” formed by the intersection of the cylinder and the plane is a circle. At any other angle this intersection results in an elliptical trace. If the cylindrical part (i.e., the feed pipe end) is cut differently from ninety degrees, the section will have an elliptical shape. To achieve an interference fit when jointed to a flat part, an elliptical orifice must be cut. This method is widely used for joining pipes and tubes to flat surfaces.

The latter conventional method has several limitations. To make a proper interference fit at different angles, differently-shaped elliptical openings in the inlet orifice are needed; one specifically configured elliptical orifice will not suffice for all installations. This means that specially configured parts with different openings suitable for different joint angles must be available in inventory. Because it is impossible to have an unlimited number of parts in inventory, the installers are limited to a few standard installation angles. This is the case for cast parts because it is unpractical to have many casting patterns or dies. Pipes must be cut under different angles too, on a case by case basis using specialized equipment. However, custom pipe cutting operations in the field are costly and time consuming.

### SUMMARY OF THE INVENTION

Our blast aerator nozzle be mounted in a variety of operating orientations. Instead of the prior art elliptical inlet orifice, a pipe-receptive inlet orifice comprising a three-dimensional cone is provided. This new interference is achieved by using material that is one inch thick or more. No additional elements such as bossed or hubs are added to the design.

The nozzle comprises a flat base and an upper, arcuate portion, with integral sidewalls therebetween. An inlet orifice in the flat body portion is specially shaped like a cone. It is in fluid flow communication with a nozzle outlet that is to be aimed in the direction of clogged material. As a result, the rigid pipe from the blast aerator, to which it is connected, can assume a variety of angles and still make a dependable connection. The feed pipe is preferably welded to the nozzle once the combination is properly oriented by the installer. An airtight seal is made during welding, as the void regions between the pipe periphery and the circumference the inlet seat the weldment. Because the feed pipe may be fitted to the nozzle at so many angles and orientations, it is suitable for a wide variety of job applications.

The nozzle has a somewhat bell-shaped body. The input orifice is defined near the upper vertice of the body, on a flat side adapted to be flush with the application. The opposite, integral side of the nozzle is arcuate, to reduce interference with material flow. The cone-like periphery of the inlet orifice eases fitting problems.

Thus a basic object is to provide a highly reliable nozzle that fits a variety of applications for conventional blast aerators or air cannons.

Another broad object is to provide a “universal” blast aerator nozzle.

A more particular object is to provide a nozzle consisting of minimal parts and which has a unique three-dimensional interference for accommodating different mounting angles between the feed pipe and the nozzle body.

Another object is to minimize metal cutting operations. In our invention, only a welding operation that attaches both parts together at a desired angle is needed.

Yet another important object is to provide a nozzle of the character described that accommodates a wide variety of different angles between the feed pipe and the nozzle body.

It is a related object to provide a universal nozzle of the character described that can be easily installed in the field, even if the resultant installation angle was not known at the time the nozzle was fabricated.

Another object is to provide a nozzle for field installation that can be shipped to the customer or job site without special pipes. It is an important feature of our nozzle that it requires only standard pipe that can be purchased by the end user from local suppliers.

A related object is to provide a nozzle of the character described that does not require special pipe cutting operations at the job site.

Another basic object is to provide a blast aerator nozzle that can accommodate angular mounting orientations in all four directions (i.e., left, right, forward, and backwards), so it is suitable for installation in very complicated surfaces.

Yet another object is to provide a nozzle design which minimizes inventory requirements. Through our design, only one special part (i.e., the nozzle body) must be maintained in inventory. Further, only one only standard part (i.e., standard pipe) must be maintained in inventory to accommodate a variety of different angles and mounting configurations.

Another object is to provide a nozzle characterized by a very simple inlet opening, unlike the prior art elliptical opening that requires special calculations to build. It is a feature of our nozzle that the inlet is shaped like a cone with two cylindrical bases.

A similar object is to provide a nozzle that fits a variety of pipes. It is a feature of our invention that the aerator customer may complete installation with standard pipes that may already be in his inventory, so the customer avoids the costs of custom piping and the attendant shipping costs.

A fundamental option is to provide a nozzle of the character described that eases the installers job. It is a feature of our invention that a variety of operational angles and orientations may be assumed with a minimum of installer inconvenience

Another object is to provide a universal aerator nozzle that can be readily fitted to pipes with straight cuts, so that custom pipe cutting and pipe fitting is not required.

Another object is to minimize the number of parts that an installer or manufacturer of aerators must maintain in inventory.

A still further basic object is to provide a nozzle for blast aerators that may quickly be installed upon a variety of applications at a variety of angles and orientations.

A still further object is to provide a universal nozzle assembly of the character described that can be readily employed with existing blast aerators, and conventional piping.

Yet another object is to provide a universal nozzle assembly of the character described that may be employed in high temperature refractory installations.

These and other objects and advantages of this invention, long with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is a fragmentary, exploded isometric view of our new universal blast aerator nozzle, with portions broken away for clarity;

FIG. 2 is a fragmentary, isometric assembled view of our new universal blast aerator nozzle, with portions broken away for clarity;

FIG. 3 is an enlarged isometric assembled view, with portions broken away for clarity;

FIG. 4 is an isometric view of the preferred nozzle showing the feed orifice and the discharge mouth;

FIG. 5 is a top plan view of the preferred nozzle;

FIG. 6 is front plan view of the preferred nozzle, looking into the discharge mouth;

FIG. 7 is a sectional view taken generally along line 7-7 of FIG. 6;

FIG. 8 is an enlarged diagrammatic, sectional view similar to FIG. 7, but showing how the aerator feed pipe may be received within the inlet at a variety of angles;

FIG. 9 is a fragmentary, sectional assembly view showing a feed pipe entering the nozzle inlet at a perpendicular angle, in which contact is made with the internally beveled periphery of the inlet orifice;

FIG. 10 is a fragmentary, sectional assembly view showing a feed pipe connecting at sixty degrees with a nozzle mounted within a recess defined in an acutely inclined wall;

FIG. 11 is a fragmentary, sectional assembly view showing a feed pipe connecting at ninety degrees with a nozzle mounted within a recess defined in an upright, vertical wall;

FIG. 12 is a fragmentary, sectional assembly view showing a feed pipe connecting at with an oblique nozzle mounted within a recess defined in a vertically oriented wall;

FIG. 13 is a fragmentary, sectional assembly view showing a feed pipe connecting at 120 degrees with a nozzle mounted within a recess defined in an obtusely angled internal wall;

FIG. 14 is a fragmentary, sectional assembly view similar to FIG. 10 showing a feed pipe connecting at sixty degrees with a nozzle mounted within a recess defined in an acutely inclined wall, with the nozzle oriented for a side-directed output;

FIG. 15 is a fragmentary, sectional assembly view similar to FIG. 11 showing a feed pipe connecting at ninety degrees with a nozzle mounted within a recess defined in a vertically upright wall, with the nozzle oriented for a side-directed output; and,

FIG. 16 is a fragmentary, sectional assembly view similar to FIGS. 10 and 14, showing a feed pipe connecting at sixty degrees with a nozzle mounted within a recess defined in an acutely inclined wall, with the nozzle oriented for side-directed output 180 degrees from the orientation of FIG. 14;

FIG. 17 is an isometric view of an alternative embodiment of the nozzle that comprises an external lip for supporting fire-resistant material;

FIG. 18 is a top plan view of the alternative nozzle;

FIG. 19 is a front elevational view of the alternative nozzle, taken from a position generally beneath FIG. 18;

FIG. 20 is a right side view of the alternative nozzle, taken from a position generally to the right of FIG. 19; and,

FIG. 21 is an enlarged, fragmentary, sectional view of the alternative nozzle installed in a high temperature kiln, showing the preferred temperature-resistant protector layer.

### DETAILED DESCRIPTION

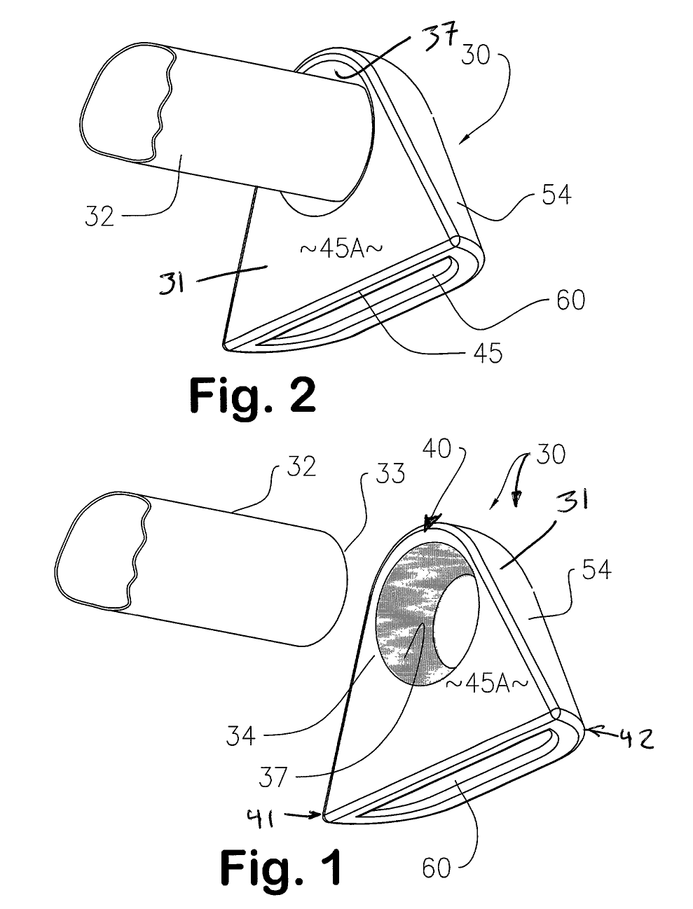

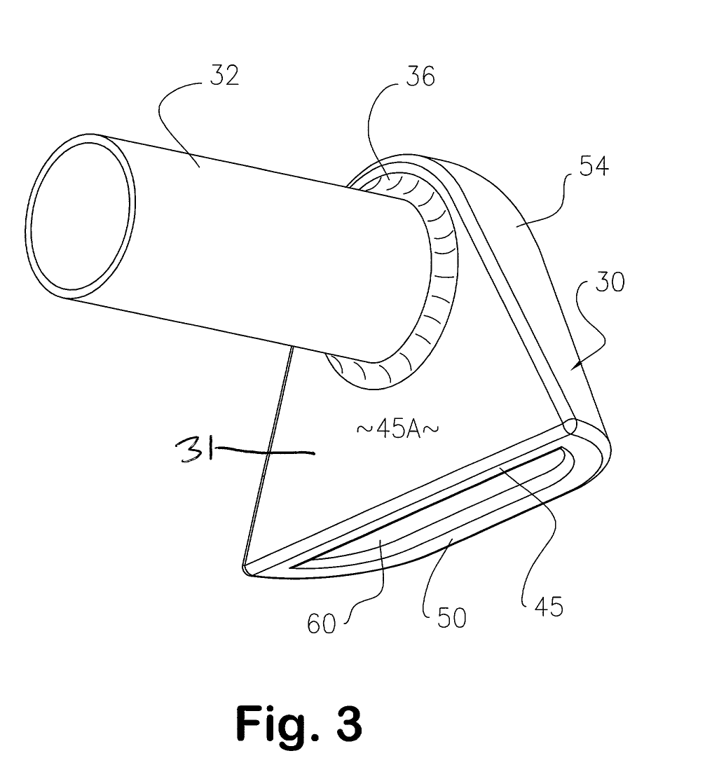

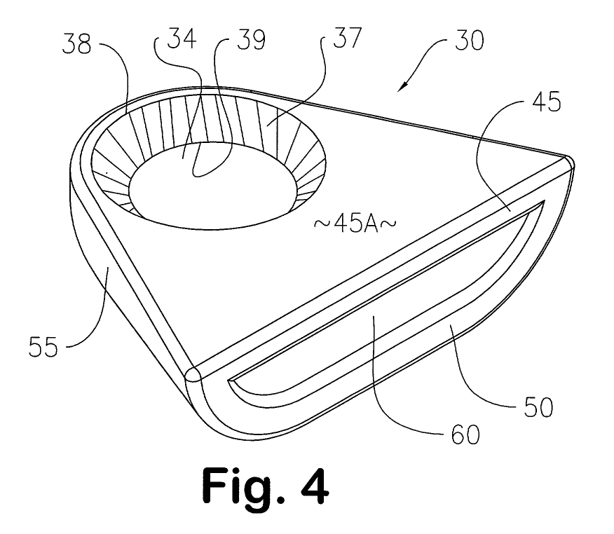

With initial reference now directed to FIGS. 1-9 of the appended drawings, a blast aerator discharge nozzle constructed in accordance with the best mode of our invention has been broadly designated by the reference numeral 30. Comparing FIGS. 1 and 2 it will be quickly appreciated that the discharge nozzle 30 is adapted to be coupled to a suitable, rigid feed pipe 32 that leads though conventional fittings, couplings and the like to a spaced-apart blast aerator that will discharge through the nozzle 30 via pipe 32. The terminal end 33 of pipe 32 fits within the input orifice 34 provided in the body 31 of the nozzle 30. It is preferably secured by welding once the nozzle is properly oriented relative to the intended job application, as described hereinafter. When pipe end 33 is suitably fitted within orifice 34, and the desired orientation and angular position of both the pipe and the nozzle are established, welding secures the parts together in proper position. A suitable peripheral weldment 36 (FIG. 3) is concentrically formed about orifice 34, making physical contact with the peripheral edges of the generally cone-shaped internal periphery 37 (FIG. 4) of the input orifice 34. The orifice input is shaped like a cone, comprising two circular bases, 38 and 39 (FIG. 4). The smaller base is a circle 39 with a diameter equal to or slightly larger that the diameter of the pipe to be received. Circle 38 has a diameter appreciably larger than the feed pipe. The cone shaped periphery 37 surrounds the output end of a pipe to be received by and welded to the nozzle. Surface 37 may be described as resembling the outer surface of a truncated cone.

Every nozzle design can accommodate only one diameter of pipe, it cannot accommodate different diameters. The preferred nozzle is designed for four-inch pipe that has 4.5 inch outside diameter.

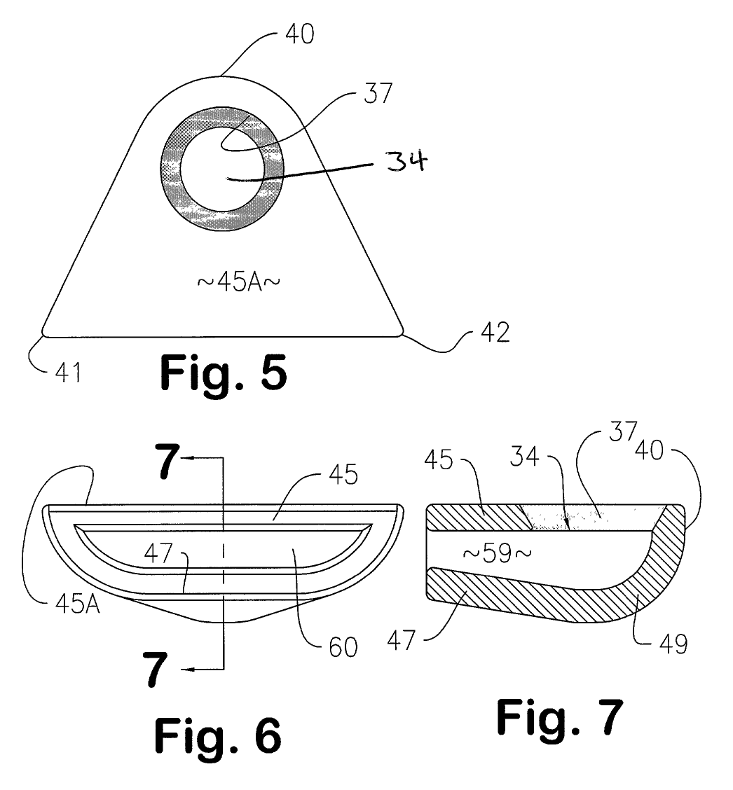

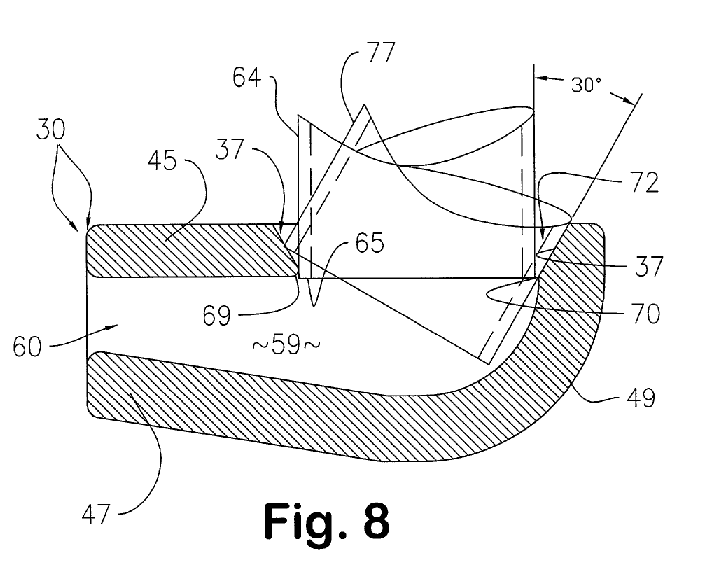

As seen in the Figures, the preferred nozzle 30 is somewhat bell-shaped or triangular in plan. The upper vertice 40 is rounded, and the companion lower vertices 41, 42 are angularly sharper. A flat, generally triangular or bell-shaped integral wall 45 presents a smooth, front face 45A facing the viewer in FIG. 5. The integral lower wall 47 (FIG. 6) is arcuate, comprising a radiused end portion 49 (FIG. 7) emanating from edge 50 (FIG. 4) that curves around and integrally terminates in upper vertice 40. This gently curved region is normally exposed to bulk material flow, so it configured to minimize drag and resistance. Exposed outer surface 45A, as discussed hereinafter, is ordinarily flushly disposed against an internal surface, within a recess where provided, when nozzle 30 is properly mounted. Walls 45 and 47 are spaced apart by the contiguous side walls 54, 55 respectively seen in FIGS. 3 and 4. The preferably-somewhat rectangular blast outlet orifice 60 is defined between walls 45 and edge 50, and between edge walls 54 and 55 (i.e., FIGS. 3, 4). The nozzle interior 59 (FIGS. 7, 8) establishes fluid flow communication between the round inlet orifice 34 and the somewhat rectangular outlet orifice 60, which is actually in the form of a tunnel. Preferably the entire nozzle 30 is made of high temperature alloy steel. It will be appreciated that gases delivered to the nozzle from feed pipe 32 enter at an angle equaling the angle of intersection between pipe 32 and surface 45A (i.e., FIGS. 1, 2) but they are outputted along a redirected path established by orifice 60 that may be as much as ninety degrees relative to the angle of intersection between pipe 32 and surface 45A. Comparing FIGS. 5, 6 and 7, it can be seen that the axis of orifice 34 is oriented substantially at right angles to the length of cavity 59 and thus the “axis” of blast output orifice or tunnel 60.

Comparing FIGS. 7 and 8, the generally conical periphery 37 (FIG. 4) around the input orifice 34 establishes a cone-like periphery that eases fitting problems experienced by the installer. In other words, with the constructions disclosed, it is more practicable to establish a mechanically sound, and pressure-sealed junction between the pipe 32 and the nozzle, once both are secured in the desired orientation, simply through welding. Little or no on-sire machining is ordinarily necessary. Noting FIG. 8, for example, a pipe 64 has penetrated orifice 34, with its end 65 disposed generally adjacent the lowermost corners of the conical periphery 37 of inlet 34. Pipe 64 is substantially perpendicular to nozzle wall 45 and to face 45A previously described. Subsequent welding secures pipe 64 in proper position, with the resultant weldment occupying the triangularly-profiled, concentric void 72 (FIG. 8) between the unwelded pipe 64 and the nozzle 30.

Pipe 77, on the other hand, enters orifice 34 at an angle. It is permitted to do so by the conical interior configuration of orifice 34. As illustrated, one edge of pipe 77 flushly abuts conical periphery 37, and the opposite pipe end 65 sharply contacts the conical orifice periphery. Nevertheless, a suitable weld not only mechanically secures the pipe and nozzle, but adequately seals juncture against air leaks as well. Many other varying orientations can be operatively established between aerator output pipes and our new flange because of the aforementioned construction.

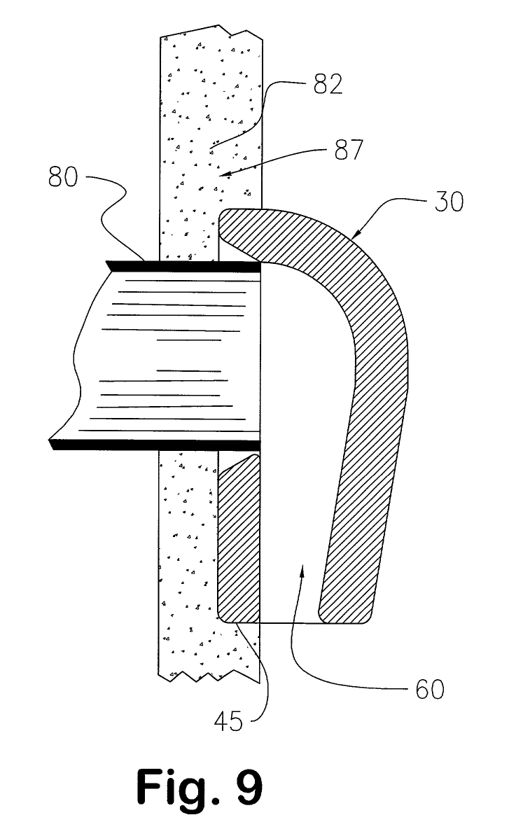

For example, FIG. 9 illustrates a horizontal pipe 80 passing through a vertical wall segment 82 of a hopper, bin or the like. In this example, wall nozzle 45 is substantially flatly positioned against the inner wall surface 87 or wall segment 82. Nozzle outlet orifice 60 is directed downwardly towards bulk material to b dislodged.

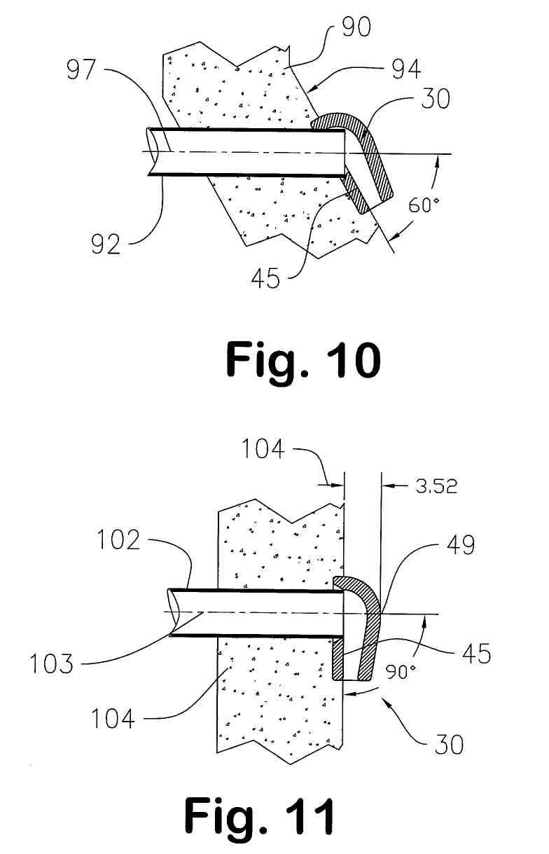

FIG. 10 shows an angled hopper wall 90 penetrated by a horizontally oriented feed pipe 92 that penetrates the interior of the nozzle 30. In this example, the nozzle is received within a suitable mounting recess formed in the angled internal surface 94 of hopper wall 90. In this “sixty degree” installation, nozzle wall 45 forms a sixty degree angle with respect to the longitudinal axis 97 of the feed pipe 92.

In FIG. 11, a substantially horizontally oriented feed pipe 102 penetrates a vertical wall 104 and reaches the interior of nozzle 30. Again, nozzle 30 is nested within a mounting recess formed in wall 104. In this “ninety degree” installation, nozzle wall 45 forms a ninety degree angle relative to the longitudinal axis 103 of the feed pipe 102. The nozzle output is directed straight down (as viewed in FIG. 11) towards material to be dislodged. Since the nozzle is disposed within a recess, the nozzle extends into the bin interior only approximately 3.52 inches, as indicated by arrows 104.

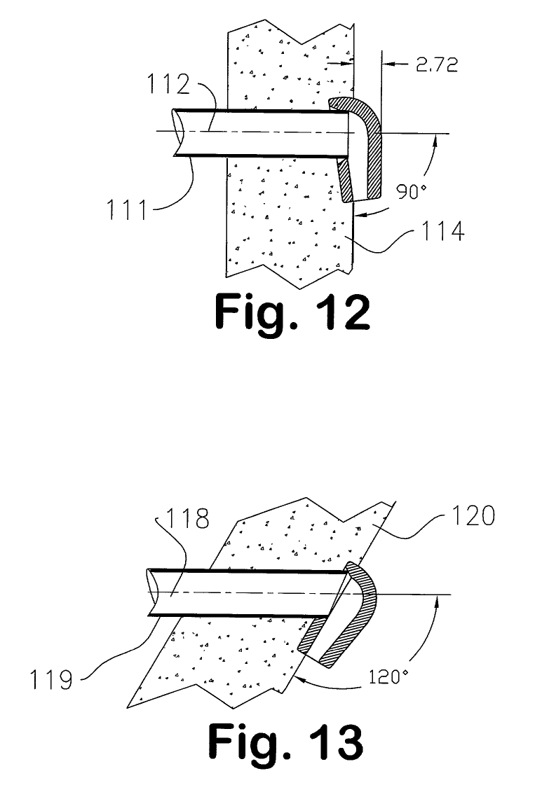

The installation of FIG. 12 is similar. Pipe 111 meets the nozzle at an acute angle. However, the longitudinal axis 112 of the pipe is perpendicular to the wall 114. The output of the nozzle is directed at an angle away from the plane of wall 114.

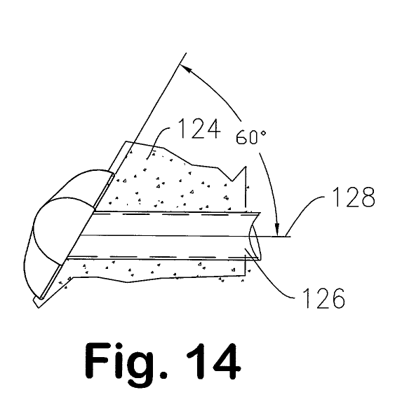

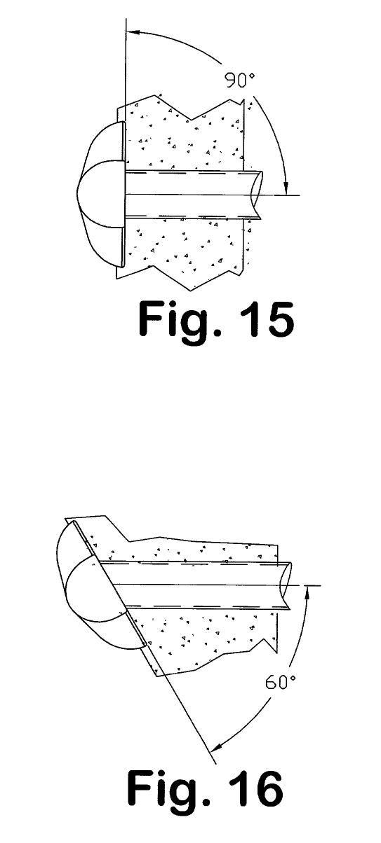

In FIG. 13, longitudinal axis 118 of the pipe 119 forms an angle of 120 degrees with resect to the wall 120. is perpendicular to the wall 114. Again, the nozzle is nested within a suitable mounting recess defined in the wall. The opposite walls or side of the bin may resemble wall 124 of FIG. 14. Here, pipe 126 has a longitudinal axis 128 forming a sixty degree angle relative to the inclined, inner wall 124. However, the nozzle 30 is oriented to direct its blast away from the viewer; in other words, the nozzle is revolved or twisted about axis 128 approximately ninety degrees from the positions of FIG. 12 or 13 prior to welding. It is aimed “sideways” instead of upwardly or downwardly. Similarly, FIGS. 15 and 16 respectively indicate “ninety degree” and “sixty degree” installations, where the nozzle output is aimed sideways. The ability to assume these different orientations is enhanced by the shape and size of the utility orifice 34 mentioned previously.

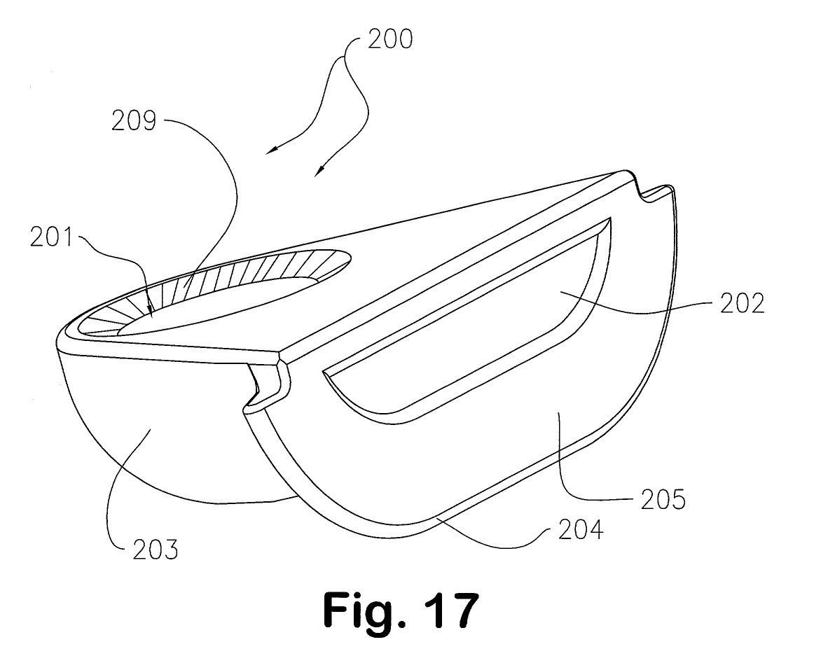

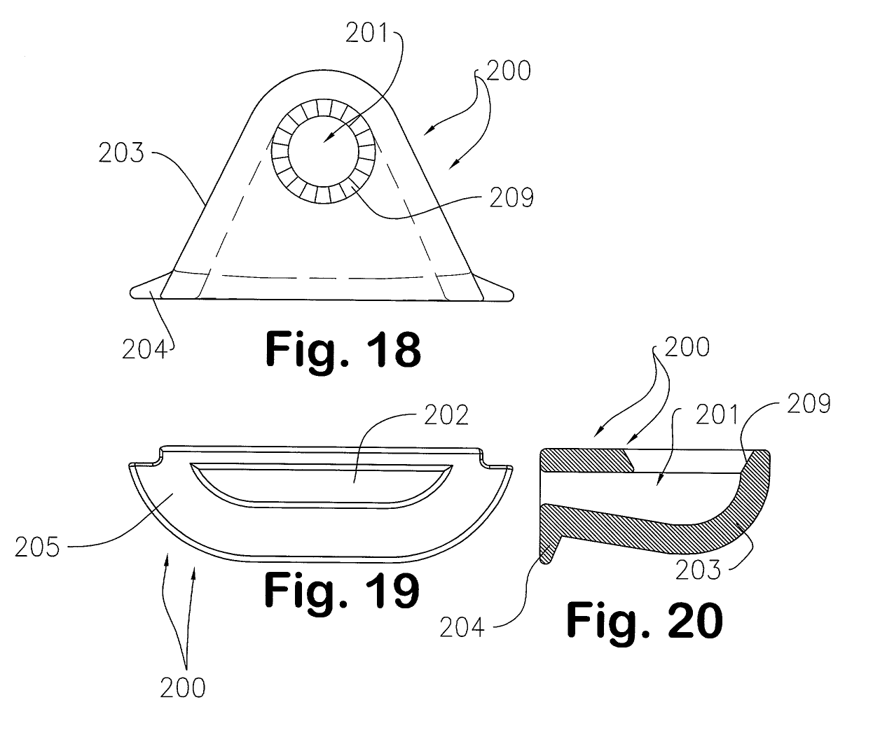

Turning now to FIG. 17-21, an alternative nozzle 200 comprises an inlet 201 formed within a rigid body 203. An outlet 202 is formed in outlet end 205. As before, it is preferred that the periphery 209 of the orifice 201 be conical. Importantly, the nozzle comprises an integral, outwardly projecting foot 204 that rises away from end 205. The foot 204 provides a brace for a temperature resistant refractory cover in high temperature applications.

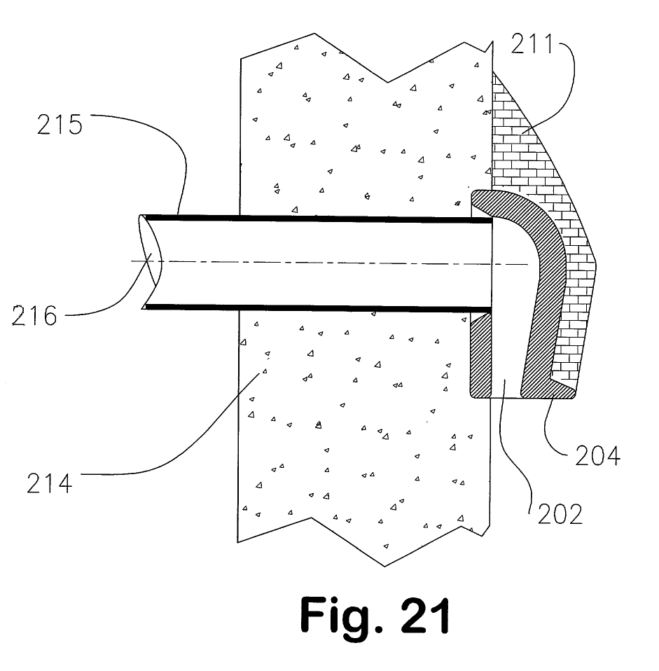

For example, FIG. 21 shows an installation within a high-temperature kiln. The kiln wall 214 is penetrated by feed pipe 215. The blast aerator output is directed though the interior 216 of feed pipe 215 for output within the kiln through outlet 202. A refractory covering 211 is conventionally formed upon the nozzle, being secured upon the nozzle foot 204.

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the accompanying drawings is to be interpreted as illustrative and not in a limiting sense.

What is claimed is:

1. A blast discharge nozzle adapted to disposed in a plurality of user-selectable configurations, the nozzle comprising:
a rigid body adapted to be coupled to the output end of a feed pipe emanating from a spaced-apart, gas output device such as a blast aerator, the body comprising a pair of spaced apart walls;
an input orifice adapted to be coupled to the output end of said feed pipe at a user-selected angle, the input orifice comprising a generally cone-shaped periphery adapted to geometrically accommodate pipes reaching the nozzle body at different angles;
an interior defined between the walls; and,
a blast output orifice in fluid flow communication with said interior and said input orifice.

2. The blast discharge nozzle as defined in claim 1 wherein the nozzle body is generally triangular, comprising an upper vertice and spaced-apart lower vertices.

3. The blast discharge nozzle as defined in claim 2 wherein the input orifice is oriented approximately ninety degrees relative to the interior.

4. The blast discharge nozzle as defined in claim 2 wherein said input orifice is disposed proximate said upper vertice.

5. The blast discharge nozzle as defined in claim 2 wherein said blast outlet orifice is substantially rectangular.

6. The blast discharge nozzle as defined in claim 1 further comprising foot means for providing a brace for a temperature resistant refractory cover in high temperature applications.

7. A blast discharge nozzle adapted to disposed in a plurality of user-selectable configurations, the nozzle comprising:
a rigid, generally triangular body adapted to be coupled to the output end of a feed pipe emanating from a spaced-apart, gas output device such as a blast aerator, the body comprising a pair of spaced apart walls, with an upper vertice and spaced-apart lower vertices.
an input orifice adapted to be coupled to the output end of said feed pipe at a user-selected angle, the input orifice comprising a generally cone-shaped periphery adapted to geometrically accommodate pipes reaching the nozzle body at different angles;
an interior defined between the walls; and,
a blast output orifice in fluid flow communication with said interior and said input orifice;
wherein the axis of the input orifice is oriented approximately ninety degrees relative to the axis of the blast output orifice.

8. The blast discharge nozzle as defined in claim 7 further comprising foot means for providing a brace for a temperature resistant refractory cover in high temperature applications.
